(19) United States
(12) Patent Application Publication
(10) Pub. No.: US 2026/0340740 A1
(43) Pub. Date: Oct. 29, 2026

(54) Methods and Systems for Predicting Cash Flow

(71) Applicant: Xero Limited, Te Aro, Wellington (NZ)

(72) Inventors: Tuan Doan, Te Aro, Wellington (NZ); Soon-Ee Cheah, Te Aro, Wellington (NZ); Brendan Law, Te Aro, Wellington (NZ); Rebecca Dridan, Te Aro, Wellington (NZ)

(21) Appl. No.: 19/119,637

(22) PCT Filed: Oct. 16, 2023
(86) PCT No.: PCT/NZ2023/050108

§ 371 Date: Apr. 9, 2025

(30) Foreign Application Priority Data
Oct. 17, 2022 (AU) 2022903039

(51) Int. Cl. G06Q 40/12; G06N 20/00

(52) U.S. Cl. CPC G06Q 40/12; G06N 20/00

(57) ABSTRACT

A computer-implemented method of predicting transaction data comprises determining a dataset of transactions occurring during a first time period; generating a numerical representation of each transaction in the dataset; determining a recursion pattern for each transaction in the dataset based on the generated numerical representations; determining at least one group of transactions from the dataset having the same recursion pattern; and predicting at least one future transaction based on the group of transactions and the recursion pattern.

### TECHNICAL FIELD

Described embodiments relate to methods and systems for predicting cash flow. In particular, described embodiments relate to systems and methods for predicting cash flow by identifying recurring transactions.

### BACKGROUND

Many businesses that fail do so because of cash flow problems. As a result, effectively predicting future cash flow is important to businesses and trading entities, enabling them to ensure adequate access to funds necessary for operational expenses while making sure that the entity's assets are invested in the most financially productive manner.

However, cash flow over a given time period can be dependent on a wide range of factors including outstanding receivables, obsolete inventory, cost of short term debt, payment obligations, liquidity and trading obligations of trading partner entities, and short term investment yields. Taking into account the large range of dynamic factors is a computationally complex, time and labour intensive operation, and can be an arduous and error prone process.

It is desired to address or ameliorate some of the disadvantages associated with prior methods and systems for predicting cash flow, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a computer-implemented method of predicting transaction data, the method comprising:
determining a dataset of transactions occurring during a first time period;
generating a numerical representation of each transaction in the dataset;
determining a recursion pattern for each transaction in the dataset based on the generated numerical representations;
determining at least one group of transactions from the dataset having the same recursion pattern; and
predicting at least one future transaction based on the group of transactions and the recursion pattern.

According to some embodiments, determining the dataset of transactions comprises identifying a set of transactions that share at least one common attribute.

In some embodiments, the common attribute is at least one of an account name, account number, contact name, transaction type, currency, or bank account number

In some embodiments, the numerical representation is a vector comprising a plurality of numerical values.

Some embodiments further comprise ordering the transactions in the group of transactions by a transaction date.

According to some embodiments, predicting at least one future transaction comprises identifying the most recent transaction in the group of transactions based and generating a new transaction date based on the recursion pattern.

Some embodiments relate to a method of training a machine learning model to generate numerical representations of transaction datasets, the method comprising:
retrieving a training dataset comprising a sequence of transactions each comprising a transaction date and a transaction amount, wherein the most recent transaction in the sequence is a target transaction and the other transactions are context transactions;
retrieving model parameters for the machine learning model;
causing the machine learning model to generate a numerical representation of each context transaction in the sequence based on the retrieved model parameters;
causing the machine learning model to generate a predicted target transaction including a predicted transaction date and a predicted transaction amount;
determining a loss function by comparing the target transaction to the predicted target transaction; and
adjusting model parameters to minimise the loss function.

According to some embodiments, the numerical representation comprises a vector comprising a plurality of numerical values.

Some embodiments further comprise retrieving a new training dataset and performing the method on the new dataset.

Some embodiments further comprise performing multiple iterations of the method to tune the model parameters.

In some embodiments, the method is continued until a predetermined number of iterations of the method have been performed.

In some embodiments, the method is continued until a decrease in the loss function for the last one or more iterations falls below a predetermined threshold.

According to some embodiments, determining the loss function comprises determining a categorical loss function.

According to some embodiments, the categorical loss function is a cross-entropy loss function.

In some embodiments, the categorical loss function is calculated for each of the day of the month, day of the week and the month of the predicted transaction date.

According to some embodiments, determining the loss function comprises determining a regression loss function.

In some embodiments, the regression loss function is a mean squared error loss function.

According to some embodiments, determining the loss function comprises determining more than one preliminary loss functions and combining each preliminary loss function into a single loss function.

According to some embodiments, the numerical representation is generated using a machine learning model trained using the method of some other embodiments.

Some embodiments relate to a method of training a machine learning model to identify a recursion pattern of a transaction dataset, the method comprising:
retrieving a training dataset comprising a sequence of transactions each comprising a transaction date and a transaction amount, each transaction having a label indicating its recursion pattern;
retrieving model parameters for the machine learning model;
generating a numerical representation of each transaction in the dataset;
causing the machine learning model to generate a transaction pattern label for each transaction in the sequence;
determining a loss function by comparing the retrieved label with the generated label; and
adjusting model parameters to minimise the loss function.

In some embodiments, the numerical representation is generated using a model that has been trained using the method of some other embodiments.

In some embodiments, the recursion pattern label corresponds to at least one of a weekly recursion, a fortnightly recursion, a monthly recursion, or no recursion.

According to some embodiments, the machine learning model is caused to generate a transaction pattern label for each transaction in the sequence using a self-attention process

According to some embodiments, performing the self-attention process comprises generating a query vector, a key vector and a value vector based on each numerical representation, and using the vectors to calculate a score for each numerical representation.

In some embodiments, performing the self-attention process comprises performing a multi-head self-attention process, by repeating the method using different initial model parameters.

In some embodiments, determining the loss function comprises determining a categorical loss function.

According to some embodiments, determining the loss function comprises determining a binary classification loss function.

In some embodiments, determining the loss function comprises determining a multi-class classification loss function.

In some embodiments, determining the loss function comprises determining a cross-entropy loss function.

According to some embodiments, determining the loss function comprises summing the loss function for multiple processed sequences of transactions.

Some embodiments further comprise performing more than one training epoch using the training dataset.

According to some embodiments, the training dataset is shuffled between training epochs.

Some embodiments further comprise determining to stop training once a predetermined number of training epochs have been completed.

Some embodiments further comprise determining to stop training once the decrease in loss function between training epochs is below a predetermined threshold.

In some embodiments, the recursion pattern is generated using a machine learning model trained using the method of some other embodiments.

### BRIEF DESCRIPTION OF DRAWINGS

FIG. 1 is a schematic diagram of a process for using a capital management platform to predict cash flow of an entity, according to some embodiments;

FIG. 2 is an example screenshot of a visual display provided by the cash flow forecast engine shown in FIG. 1, according to some embodiments;

FIG. 3 is a process flow diagram of a method for predicting a recurring transaction, according to some embodiments;

FIG. 4 is a process flow diagram of a method for training a model to generate numerical representations of transactions, according to some embodiments;

FIG. 5 is a process flow diagram of a method for training a model to determine recursion patterns, according to some embodiments;

FIG. 6 is a block diagram depicting an example application framework, according to some embodiments.

FIG. 7 is a block diagram depicting an example hosting infrastructure, according to some embodiments;

FIG. 8 is a block diagram depicting an example data centre system for implementing described embodiments;

FIG. 9 is a block diagram illustrating an example of a machine arranged to implement one or more described embodiments;

FIG. 10 is a graph showing an example of the results of executing the methods as shown in FIGS. 3 and 5;

FIG. 11 is a graph showing an example of the results of executing the methods as shown in FIGS. 3 and 4; and

FIG. 12 is a further graph showing an example of the results of executing the methods as shown in FIGS. 3 and 4.

### DESCRIPTION OF EMBODIMENTS

Described embodiments relate to methods and systems for predicting cash flow. In particular, described embodiments relate to systems and methods for predicting cash flow by identifying recurring transactions.

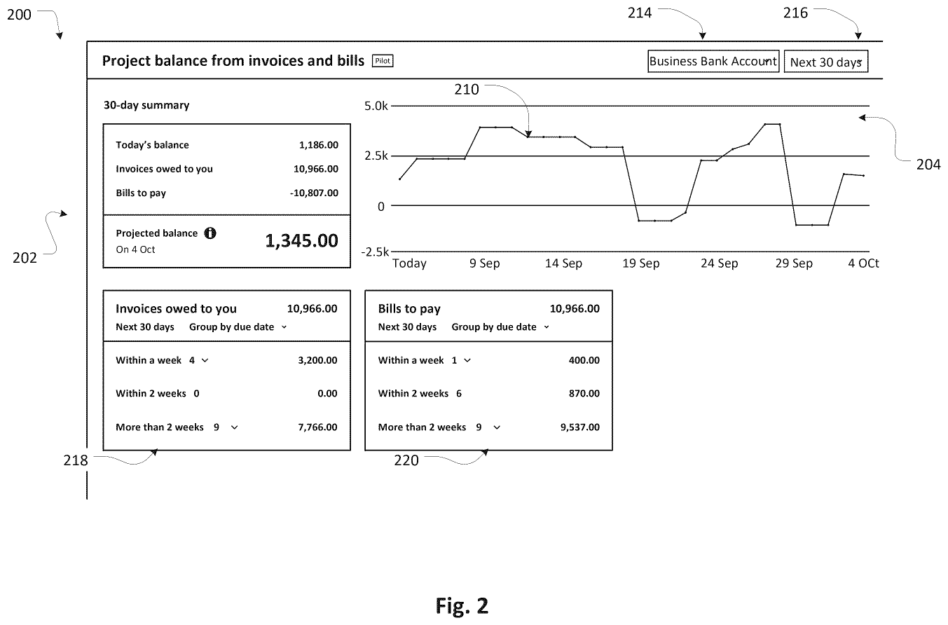

In some embodiments, a capital management platform including a cash flow forecasting platform or tool is provided. The capital management platform is configured to determine predicted capital shortfalls and/or capital surpluses of an entity for a given period of time. The capital management platform may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example of such a graphical representation is presented in FIG. 2, and is discussed in more detail below.

The capital management platform may be configured to determine the predicted capital shortfalls and/or capital surpluses at a particular point or day in a given time period based on an assessment of financial data associated with the entity. Financial data associated with an entity may comprise banking data, such as banking data received via a feed from a financial institution, accounting data, payments data, assets related data, transaction data, transaction reconciliation data, bank transaction data, expense data, tax related transaction data, inventory data, invoicing data, payroll data, purchase order data, quote related data or any other accounting entry data for an entity. The financial data may comprise one or more financial records, which may be transaction records in some embodiments. Each financial record may comprise one or more of a transaction amount, a transaction date, one or more due dates and one or more entity identifiers identifying the entities associated with the transaction. For example, financial data relating to an invoice may comprise a transaction amount corresponding to the amount owed, a transaction date corresponding to the date on which the invoice was issued, one or more payment due dates and entity identifiers indicating the invoice issuing entity and the entity under the obligation to pay the invoice. Financial data may also comprise financial records indicating terms of payment and other conditions associated with the financial transaction associated with the financial data.

In some embodiments, the capital management platform may be configured to predict capital shortfalls and/or capital surpluses for a primary entity over a time period based on data relating to historical or current transaction data, or patterns of transaction data. In some embodiments, the capital management platform may be configured to identify recurring transactions from a set of transactions such as a database of transactions (for example, past transactions) and generate a model for predicting future recurring transactions. The model may then be used to by the platform to predict recurring transactions for a given time period, which can then be used by the platform to determine or predict a baseline cash flow forecast.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

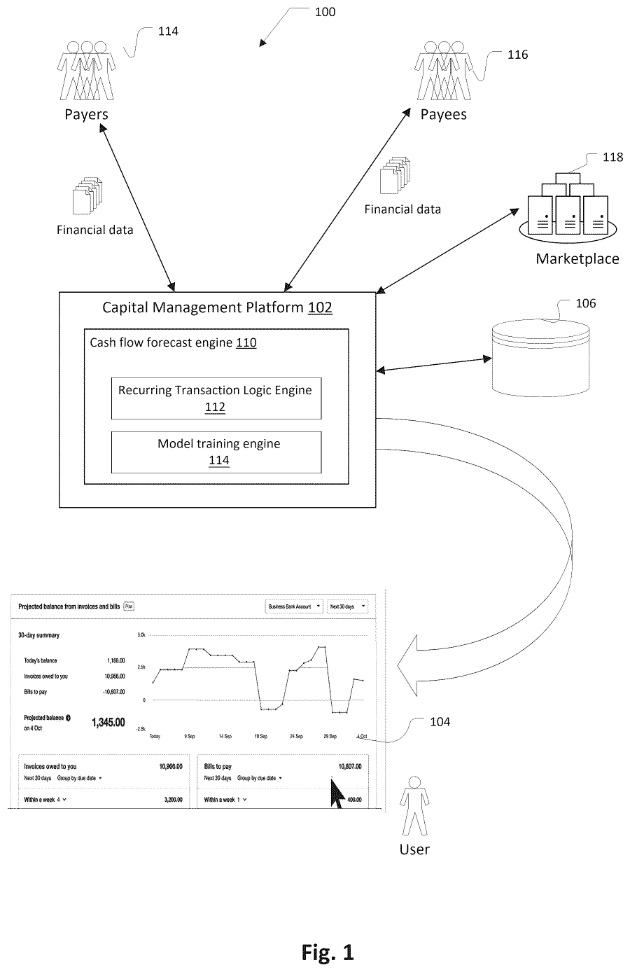

FIG. 1 illustrates a process 100 for using a capital management tool to improve capital management of an entity by forecasting future cash flow of the entity over a predetermined time period. In some embodiments, a capital management platform 102 may be provided to one or more client devices by one or more servers executing program code stored in memory. According to some embodiments, the capital management platform 102 may have the features and functions as described in PCT patent applications PCT/AU2020/050924 and/or PCT/AU2020/051184, the entire contents of both of which are incorporated herein by reference. The capital management platform 102 may provide the cash flow forecast engine 110 for use by users of the one or more client devices. In some embodiments, the capital management platform 102 is arranged to communicate with a database 106 comprising financial information associated with a network of entities associated with the capital management platform, and may, for example, include accounting data for transactions between two or more entities. Accordingly, analysis of the data allows for inferences about the business interactions or transactions of those entities. For example, computational analysis of historical patterns of transactions between entities and trading behaviours of entities including responsiveness to financial obligations may be used to predict behaviours of the entities.

Database 106 may comprise one or more databases, data centres or data storage devices, and may comprise cloud storage in some embodiments. In some embodiments, database 106 may be part of an accounting system, such as a cloud based accounting system configured to enable entities to manage their accounting or transactional data. The accounting or transactional data may include data relating to bank account transactions or transfers, invoice data, billings data, expense claim data, historical cash flow data, quotes related data, sales data, purchase order data, receivables data, transaction reconciliation data, balance sheet data, profit and loss data, payroll data, for example. Data in database 106 may enable identification of interrelationships between the primary entity and other entities based on the transactional data. The interrelationships may include relationships that define payment or debt obligations, for example. Based on the interrelationships between the primary entity and other entities, data in database 106 may be used to identify one or more networks of related entities that directly or indirectly transact with each other. Within a network of entities, the financial or cash flow position of one entity may have an impact on the financial or cash flow position of rest of the entities in the network.

The cash flow forecast engine 110 may comprise program code executable by one or more processors of the capital management platform 102. The cash flow forecast engine 110, when executed by the one or more processors of the capital management platform 102, may be configured to predict capital shortfalls and/or capital surpluses of an entity for a given period of time based on information derived from the database 106. For example, the cash flow forecast engine 110 may predict baseline capital shortfalls or baseline capital surpluses based on payment terms of transaction data, such as invoices.

The cash flow forecast engine 110 may comprise a recurring transaction logic engine 112 configured to analyse data relating to recurring transactions, such as recurring bill transactions and recurring invoice transactions undertaken by an entity, and to predict future transactions for the entity. Data relating to transactions includes data relating to bills and invoices that an entity may receive. The recurring transaction logic engine 112 may employ a predictive model such as a regression model or a trained neural network, for example, and may use historical data relating to previously received bills and invoices in order to predict future transactions that may be recurring during a given period.

The cash flow forecast engine 110 may further comprise a model training engine 114 configured to use training data, such as historical transaction data or synthetic transaction data, to generate models that can be used by recurring transaction logic engine 112 to identify recurring transactions.

The cash flow forecast engine 110 may be configured to determine a cash flow forecast based on outputs from the recurring transaction logic engine 112. In some embodiments, the cash flow forecast engine 110 may be configured to determine a baseline cash flow based on these outputs and, in some embodiments, to generate a graphical display for displaying the cash flow forecast to a user on a user interface of a client device.

In some embodiments, the cash flow forecast engine 110 may be configured to identify recurring transactions in a database of transactions (for example, past transactions) and generate a model for predicting future recurring transactions. Predicted recurring transactions for a given period may then be used by the cash flow forecast engine 110 in determining or predicting a baseline cash flow forecast.

The capital management platform 102 may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example screenshot of the visual display of the capital management platform 102 is shown in FIG. 2.

Referring now to FIG. 2, there is shown an example screenshot 200 of a visual display of the capital management platform 102. The screenshot 200 illustrates a graphical forecast or prediction relating to cash flow of a primary entity. This may include predictions relating to transactions, bills and/or invoices. Bills may comprise future payment obligations to one or more counterparties or related entities. Invoices may comprise future receivables from one or more counterparties or related entities. Section 202 provides an exemplary 30 day summary of a cash flow forecast for the primary entity, which may include forecasts for the entity's invoices and bills. Section 204 provides a graphical illustration of the cash flow forecast over the next 30 days for the entity. Points below the x-axis on the graph 204 indicate a negative total cash flow forecast at a particular point in time. Points above the x-axis indicate a positive cash flow forecast at a particular point in time. Section 204 comprises a baseline cash flow prediction line 210 indicating the cash flow position of the primary entity over the next 30 days.

Screenshot 200 also illustrates a selectable user input 214 allowing a user to select a particular account for which a cash flow prediction may be performed by the cash flow forecast engine 110. By selecting a different account from the selectable user input 214, a user may visualise a cash flow forecast for a different account for the entity. Screenshot 200 also illustrates another selectable user input 216 that allows a user to vary the duration over which the cash flow forecast engine 110 performs the cash flow prediction. A user may select a different duration of 60 days or 90 days, for example, to view a cash flow prediction over a different timescale.

Screenshot 200 also illustrates some financial data relating to invoices and bills which provides the basis for generation of the graphs in section 204. Section 218 illustrates a summary of financial data relating to invoices for the primary entity. In section 218, the financial data is summarised by the date on which an invoice is due. Section 220 illustrates a summary of financial data relating to bills for the primary entity. In section 220, the financial data is summarised by the date on which a bill is due.

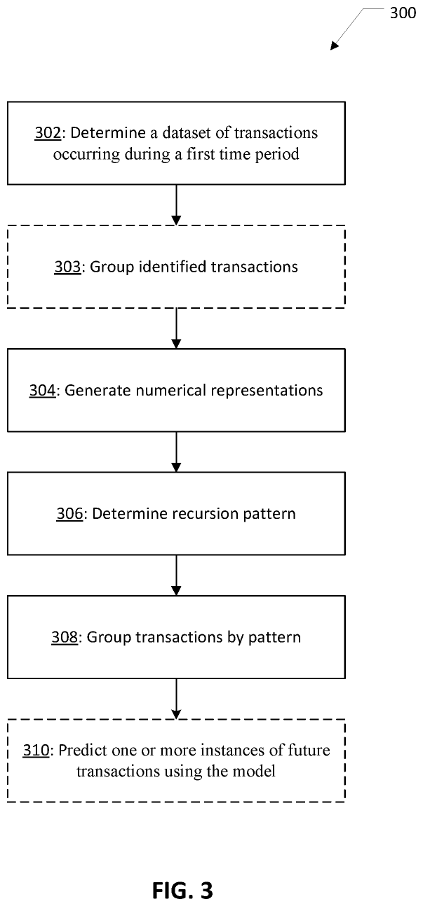

Referring now to FIG. 3, there is shown a process flow for a method 300 of predicting future transactions by identifying recurring transactions in a dataset of transactions. Method 300 may be performed by recurring transaction logic engine 112 when executed by one or more processors of the capital management platform 102. The future transactions may then be used by cash flow forecast engine 110 to determine future cash flow.

At step 302 of method 300, the recurring transaction logic engine 112 determines and/or retrieves a dataset of transactions occurring during a first pre-determined time period. According to some embodiments, the pre-determined time period may be a period of time prior to the date on which method 300 is being performed. For example, the time period may be a duration of months prior to the date on which method 300 is being performed, such as a duration of 3 months. The dataset of transactions may be determined or obtained from database 106. Database 106 may comprise financial information associated with a network of entities associated with the capital management platform 102, and may, for example, include accounting data for transactions between two or more entities and one or more accounts associated with each of those entities. The transactions may be associated with one or more entities or contacts or may be associated with a network of entities. Each transaction is associated with corresponding transaction attribute information, such as one or more of the date of the transaction, account name or type, account number, account name, contact name, contact identifier, payment or invoice amount, business registration number (such as ABN, NZBN, UK Companies House number, or the like), and/or contact address.

Optionally at step 303, recurring transaction logic engine 112 may be caused to group the transactions identified at step 302 using one or more grouping criteria, such as by selecting transactions that share a common attribute. According to some embodiments, the criteria may be selected so as to group transactions that are more likely to be sets of recurring transactions. In some embodiments, this may be done by grouping transactions that are more likely to come from the same source, such as the same biller or invoice issuer. For example, the transactions may be grouped based on one or more of an account name, account number, contact name, transaction type, currency, or bank account number, for example.

Steps 304 to 310 may then be performed for each group of transactions identified in step 303.

At step 304, the recurring transaction logic engine 112 generates a numerical representation of each transaction for a selected group of transactions. According to some embodiments, the numerical representation may be a vector comprising a plurality of numerical values. In some embodiments, the numerical representation may be an embedding of the transaction. The numerical representation may be uninterpretable by humans, but may store data relating to properties of each transaction which may include the transaction date and transaction amount, for example. The numerical representation may capture associations between properties of the transactions within the group of transactions being processed, such as the relationship between transaction dates, for example.

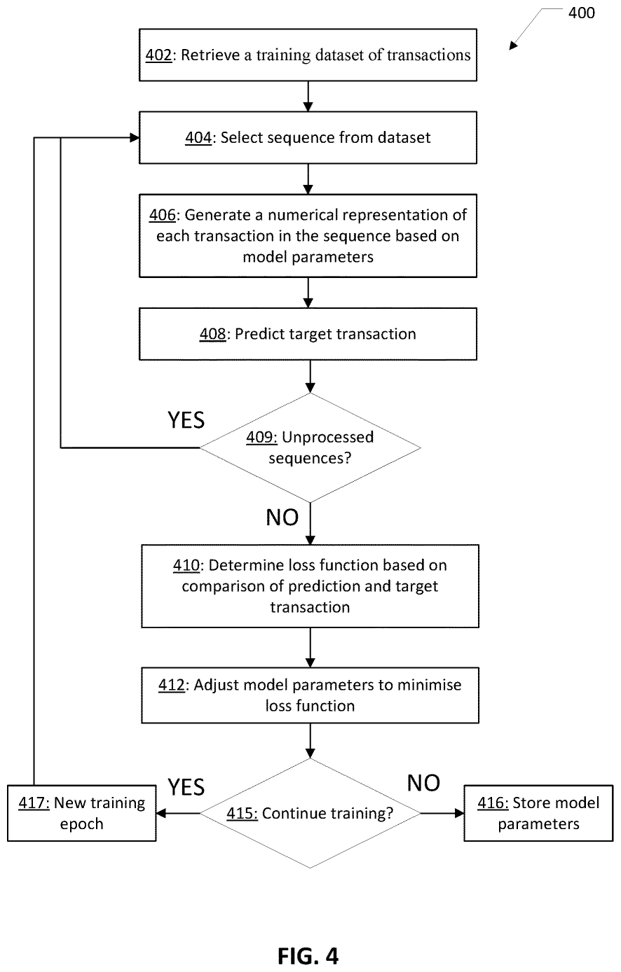

According to some embodiments, the numerical representation may be generated by a machine learning model configured to generate numerical representations of transactions, such as a machine learning model trained using the method described below with reference to FIG. 4.

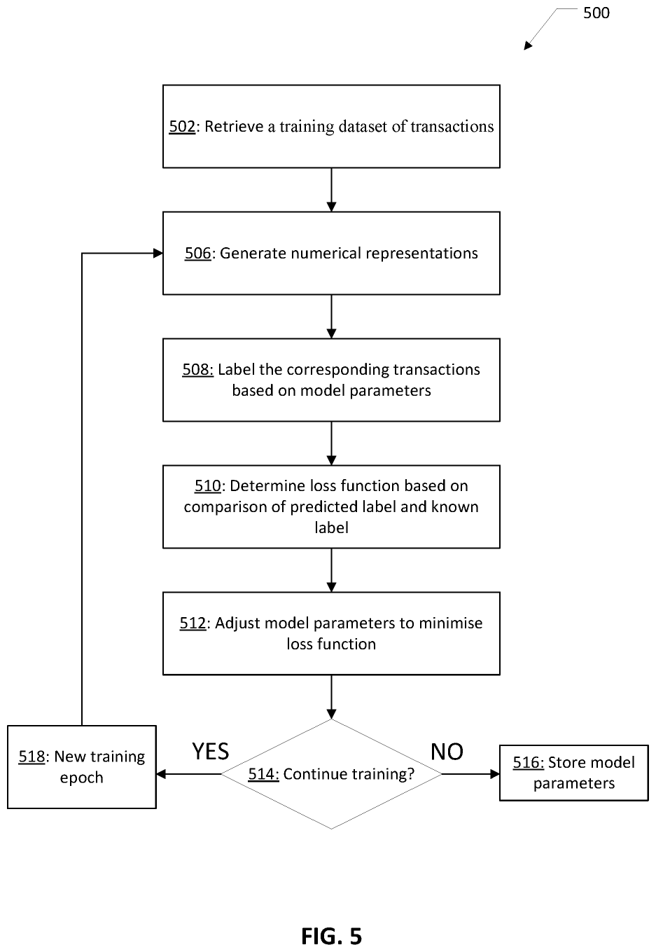

At step 306, the recurring transaction logic engine 112 determines a recursion pattern for each transaction in the group of transactions. According to some embodiments, the recursion pattern may be determined based on the numerical representation of each transaction generated at step 304. According to some embodiments, the recursion pattern may be generated by a machine learning model configured to determine recursion patterns, such as a machine learning model trained using the method described below with reference to FIG. 5.

At step 308, the recurring transaction logic engine 112 groups the transactions by the recursion pattern determined at step 306. According to some embodiments, recurring transaction logic engine 112 may further order the transactions in each group by the transaction date, so that each group comprises an ordered set of recurring transactions.

At optional step 310, the recurring transaction logic engine 112 uses the groups of transactions identified at step 308 to predict one or more instances of future recurring transactions. Recurring transaction logic engine 112 may do this based on the recursion pattern and the last known transaction identified for each group of transactions. For example, for a group of transactions that have been determined to have a “weekly” recursion pattern and where the last transaction occurred on 1 Jan. 2020, cash flow forecast engine 110 may predict a next transaction as occurring on 8 Jan. 2020.

According to some embodiments, the predicted recurring transactions may then be used by cash flow forecast engine 110 to determine a baseline cash flow prediction.

The performance of method 300 can be measured using metrics such as coverage and precision.

The coverage refers to the proportion of predictions made correctly for each organisation to the number of actual future transactions of that organisation, and may be calculated by dividing the number of correct predictions by the total number of future transactions for the organisation. For example, an organisation may have 100 transactions in the future (as at the date the predictions are being generated). Performing Method 300 may cause 80 future transactions to be predicted. Of these, 60 may be correct, while 20 may be incorrect. The coverage may be determined by dividing the number of correctly predicted transaction (60 in this example) by the number of actual future transactions (100 in this example), which may give a coverage of 0.6 in this example.

The precision refers to the proportion of correctly predicted transactions for an organisation to the total number of transactions predicted for that organisation, and may be calculated by dividing the number of correct predictions by the total number of predicted transactions for the organisation. For the above example, the coverage may be determined by dividing the number of correctly predicted transaction (60 in the above example) by the total number of predicted transactions (80 in this example), which may give a coverage of 0.75 in this example.

Where no predictions are made for an organisation, the prediction may be undefined, as the denominator of the calculation is zero. If an organisation doesn't have any transactions, the coverage may be undefined, as the denominator of the calculation is zero.

An experiment was conducted by performing method 300 on a dataset containing transactions randomly sampled from 100,000 organisations. The coverage and precision of the predicted results was determined, and are provided below.

| Metric | Metric Value |
|---|---|
| Coverage mean | 0.0938 |
| Coverage median | 0.0247 |
| Coverage undefined | 4,844 |
| Precision mean | 0.3522 |
| Precision median | 0.3333 |
| Precision undefined | 25,707 |

FIG. 4 is a process flow diagram of a method 400 for training a model to act as a numerical representation generator. Once trained using method 400, a machine learning model can be used to generate numerical representations of transactions, and may be used to perform step 304 of method 300, as described above with reference to FIG. 3. The model training engine 114, when executed by one or more processors of the capital management platform 102, may be configured to perform method 400.

At step 402, the model training engine 114 retrieves a training dataset of transactions. According to some embodiments, the training dataset may include historical transaction data that has been retrieved from database 106. According to some embodiments, the training dataset may include synthetic transaction data generated specifically for training of the model. For example, model training engine 114 may be configured to retrieve sets of synthetic transaction sequences generated based on predetermined parameters. The parameters may include one or more of a number of transactions per sequence, a range for transaction amounts, a standard deviation for transaction amounts, a range for transaction dates, and a recursion pattern for transaction dates.

For example, in some embodiments, model training engine 114 may be configured to generate sets of synthetic transaction sequences having recursion patterns of between 3 days and 31 days. In some embodiments, model training engine 114 may be configured to generate sets of synthetic transaction sequences having a transaction amount varying by a standard deviation of between 5% and 20%. The transaction amount may be selected to vary by a standard deviation of 10% in some embodiments. In some embodiments, model training engine 114 may be configured to generate sets of synthetic transaction sequences having between 3 and 10 transactions per sequence. For example, synthetic transaction sequences may have 5 transactions per sequence in some embodiments.

The dataset of transactions retrieved or generated by model training engine 114 may comprise one or more sets of transactions grouped into sequences, where each sequence comprises a series of recurring transactions T={tx₁, tx₂, . . . , txₙ}. For example, some embodiments may use a dataset having transactions grouped into sequences of five transactions T={tx₁, tx₂, tx₃, tx₄, tx₅}. The transactions may be ordered by ascending transaction date. The last transaction in the series txₙ or the transaction with the latest transaction date may be considered a “target transaction”, while the other transactions in the series may be considered “context transactions”.

Each transaction may be represented by one or more parameters, which may include at least one of a transaction date and a transaction amount, for example. According to some embodiments, model training engine 114 may be configured to extract further parameters from the transaction date, such as one or more of a day of the week, date of the month, and month of the transaction.

An example of a sequence of transactions may be:
tx₁=2022-08-28, $1000.0
tx₂=2022-09-07, $950
tx₃=2022-09-17, $1100
tx₄=2022-09-27, $970
tx_{target}=2022-10-07, $1005

At step 404, the model training engine 114 selects a first sequence of transactions from the training dataset.

At step 406, the model training engine 114 generates a numerical representation for each context transaction in the selected sequence based on the current model parameters, which may be stored in database 106. According to some embodiments, the numerical representation may be a vector comprising a plurality of numerical values. The model parameters may control how a transaction is mapped to a numerical representation. Prior to the first iteration, the model parameters may be set to a default value such as 0 or 1, for example. This may cause the numerical representations generated at step 406 to be relatively random during the initial iterations of method 400. The numerical representations may become more accurate as the model parameters are tuned after multiple iterations of method 400 have been performed.

At step 408, the model training engine 114 uses the numerical representations of the context transactions to predict the next transaction in the sequence, being the target transaction. The prediction generated by model training engine 114 may comprise transaction parameters such as at least one of a predicted transaction amount and a predicted transaction date.

At step 409, the model training engine 114 determines whether further unprocessed sequences exist in the dataset retrieved at step 403. If unprocessed sequences exist, model training engine 114 may continue executing method 400 from step 404, by selecting a new sequence from the training dataset.

If no unprocessed sequences exist in the dataset, model training engine 114 may determine that a training epoch has been completed, and move to step 410.

At step 410, the model training engine 114 determines a loss function by comparing the transactions predicted at step 408 with the target transactions of the selected sequences. According to some embodiments, the loss function may be determined by comparing the parameters of the transactions predicted at step 408 with the parameters of the target transactions of the selected sequences. For example, the transaction amount predicted at step 408 for a particular sequence may be compared with the transaction amount of the target transaction for that sequence, and/or the transaction date predicted at step 408 for a particular sequence may be compared with the transaction date of the target transaction for that sequence.

According to some embodiments, determining the loss function may be used as a manner of penalising the model for making incorrect predictions. A correct prediction, being a prediction that matches the target transaction, may result in a loss function of zero. Any derivation from the target transaction may increase the calculated loss function.

Determining the loss function may comprise determining at least one of a categorical loss function and a regression loss function.

The categorical loss function may include a binary classification loss function or a multi-class classification loss function, and may be used to quantify the difference between a predicted transaction date and an actual transaction date of a target transaction. For example, a cross-entropy loss function may be used in some embodiments. According to some embodiments, more than one categorical loss function may be calculated. For example, a categorical loss function may be calculated for each of the day of the month, day of the week and the month of a predicted transaction date.

The regression loss function may be used to quantify the difference between a predicted transaction amount and an actual transaction amount of a target transaction. For example, a mean squared error loss function may be used in some embodiments.

Where more than one loss function are used, the determined loss functions may be combined to produce a single loss function for each prediction. In some embodiments, the individual loss functions may be summed to derive a total loss function. In some embodiments, the individual loss functions may be weighted before being summed.

Where multiple sequences of transactions have been processed, the loss function may comprise the sum of the loss functions for each processed sequence of transactions.

At step 412, the model training engine 114 adjusts or tunes the model parameters to minimise the loss function determined at step 410.

At step 415, the model training engine 114 determines whether to continue training the model. According to some embodiments, the model training engine 114 may do this by comparing the completed number of training epochs against a predetermined number of training epochs to complete, to check whether the desired number of training epochs have been performed. In some embodiments, the model training engine 114 may alternatively determine whether to continue training by determining whether the decrease in the loss function for the last one or more sequences of training data have been below a predetermined threshold. As the change to the loss function becomes smaller from one iteration to the next, this may indicate that further training will have a negligible effect on the accuracy of the model.

If the model training engine 114 determines that more training is required, model training engine 114 may proceed to step 417, at which a new training epoch is initiated. The sequences in the dataset retrieved at step 402 are marked as unprocessed and may be shuffled in some embodiments, and model training engine 114 continues by executing method 400 from step 404, by selecting a new sequence from the training dataset to begin the new training epoch.

If the model training engine 114 determines that no more training is required, model training engine 114 may proceed to step 416, by storing the tuned model parameters for use in generating numerical representations of transactions, as described above with reference to step 304 of method 300.

By iteratively tuning the model parameters as described, the trained model is configured to generate numerical representations of transactions that preserve features of the transactions that allow the recursion patterns of the transactions to be determined. For example, the model may be able to generate numerical representations that preserve information such as a day, date or month in which a transaction occurred, and the length of time between transactions in a sequence. Furthermore, the generated numerical representations may contain data that represents relationships between certain days or dates. The data may contain data that links days, dates or months based on their temporal proximity or other parameters, such as whether or not they are a business day. For example, the date “30th” may be more closely linked to “1^{st}” than “25^{th}”. The day “Sunday” may be more closely linked to “Saturday” than “Monday”.

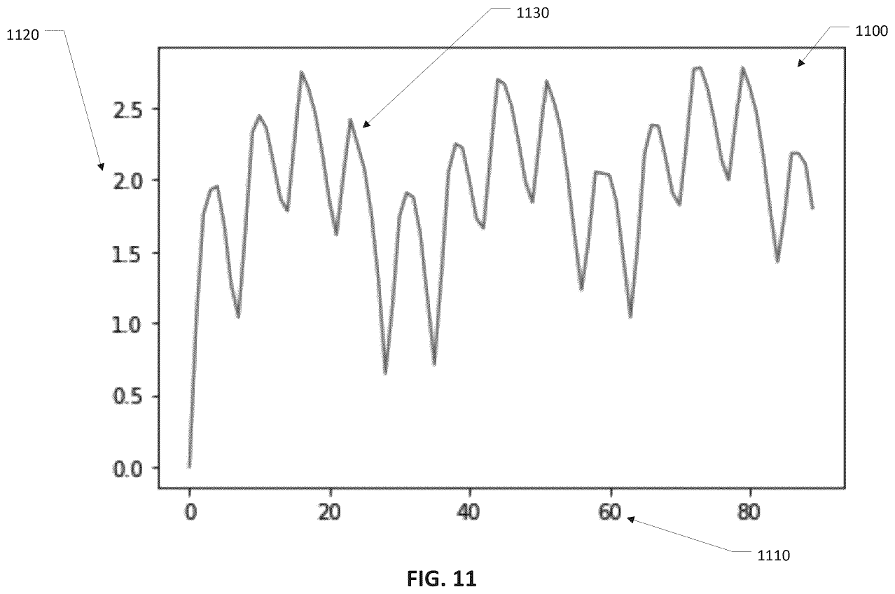

FIG. 11 is an example graph 1100 showing the results of using the methods of FIGS. 3 and 5 to label a number of synthetically generated transactions. Specifically, graph 1100 was generated by using recurring transaction logic engine 112 to execute step 304 of method 300 on a synthetic dataset containing a transaction sequence. The sequence contained 100 transactions having the same transaction amount and dates within the range of [2021-01-01, 2021-01-01+100 days].

Graph 1100 has an x-axis 1110 showing the transaction number, and a y-axis 1120 showing the Euclidian distance between the embedding for the first transaction and each other embedding as generated by recurring transaction logic engine 112 executing step 304 of method 300.

Line 1130 shows the Euclidean distance between the embedding for each transaction in the sequence in relation to the embedding for the first transaction. As seen from graph 1100, the embeddings show the cyclicity of weeks and months, as illustrated by the dips in the graph every 7 and 30 days.

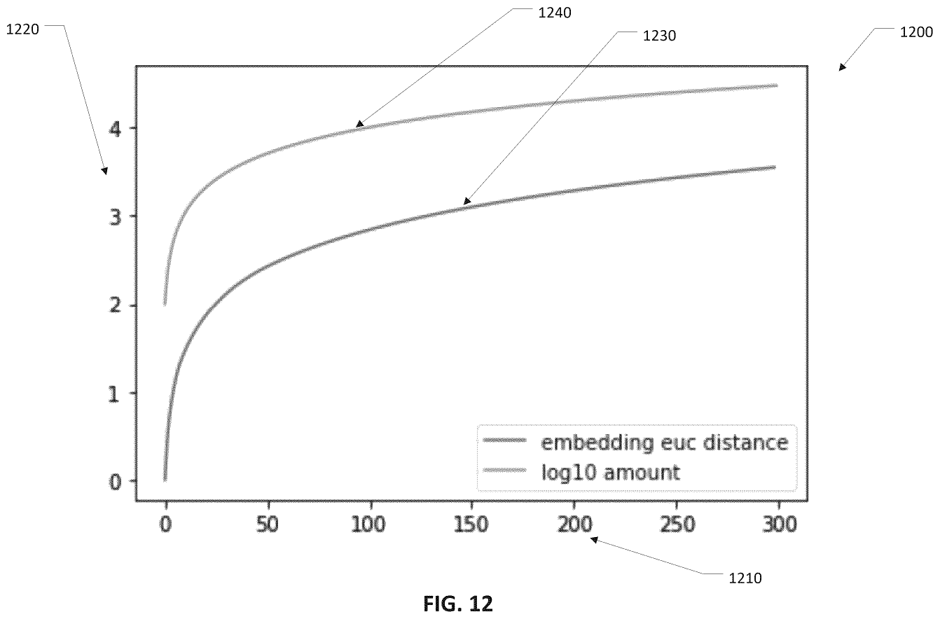

FIG. 12 is a further example graph 1200 showing the results of using the methods of FIGS. 3 and 5 to label a number of synthetically generated transactions. Specifically, graph 1200 was generated by using recurring transaction logic engine 112 to execute step 304 of method 300 on a synthetic dataset containing a transaction sequence. The sequence contained 300 transactions having the same transaction date and transaction amounts between $100 and $30,000 with the amounts incrementing by $100.

Graph 1200 has an x-axis 1210 showing the transaction number, and a y-axis 1220 showing the Euclidian distance between the embedding for the first transaction and each other embedding as generated by recurring transaction logic engine 112 executing step 304 of method 300.

Line 1230 shows the Euclidean distance between the embedding for each transaction in the sequence in relation to the embedding for the first transaction. As seen from graph 1100, the embeddings show that the amounts are encoded. As the transaction amount increases, the distance between the embeddings follows a similar curve to the log 10 of the amount differences, as shown by line 1240.

FIG. 5 is a process flow diagram of a method 500 for training a model to identify recursion patterns. Once trained using method 500, a machine learning model can be used to label transactions based on their determined pattern of recursion, and may be used to perform step 306 of method 300, as described above with reference to FIG. 3. The model training engine 114, when executed by one or more processors of the capital management platform 102, may be configured to perform method 500. The model trained using method 500 may be a neural network model in some embodiments.

At step 502, the model training engine 114 retrieves a training dataset of transactions. The training dataset may contain at least one subset of transactions, represented by transaction parameters. For example, each transaction may be represented by at least one of a transaction amount and a transaction date. In some embodiments, the training dataset may include transactions that are both recurring and non-recurring. Each transaction in the dataset may be labelled with an associated recursion pattern. For example, the transactions may be labelled as “weekly”, “fortnightly”, “monthly” or “no pattern”, in some embodiments.

According to some embodiments, the training dataset may include historical transaction data that has been retrieved from database 106. According to some embodiments, the training dataset may include synthetic transaction data generated specifically for training of the model. According to some embodiments, the training dataset may comprise synthetic transaction data generated using the method as described in the Australian Provisional Patent Application titled “Methods and systems for generating synthetic data” and filed on 17 Oct. 2022 by Xero Limited, the entire contents of which are incorporated herein by reference.

At step 506, numerical representations of the retrieved transactions are generated, as described above with reference to step 304 of method 300.

At step 508, the model training engine 114 generates a label or category for each transaction based on the numerical representations and the current model parameters, which may be stored in database 106. Model training engine 114 may use a self-attention process to generate labels based on the numerical representations and the current model parameters. This may involve generating a query vector, a key vector and a value vector based on each numerical representation generated at step 506. The process may further involve calculating a score for each numerical representation by determining the dot product of the query vector and the key vector of the embedding, dividing by the square root of the dimensions of the key vectors, and normalising the scores via a weighting process such as using a softmax operation. The value vectors may then be multiplied by the softmax score, and the calculated weighted value vectors may be summed for produce the output of the self-attention layer for that embedding. Where Q is the Query vector, K is the key vector and V is the value vector, this process may be performed by determining the equation:

$$Z = softmax ( \frac{Q \times {K}^{T}}{\sqrt{{d}_{k}}} ) V$$

The dimensionality or size of the key and query vectors used in the method may be varied to achieve different results. Increasing the dimensionality of the vectors used may increase the model capacity, but also increase the model size and training/inference time.

In some embodiments, model training engine 114 may use a multi-head self-attention process, where steps 506 to 518 may be performed multiple times with different initial values of the model parameters, which may allow different sets of recurring transactions to be identified. Each iteration of the method steps with a different set of initial model parameters may be considered a separate “head” of the process. Increasing the number of heads used may increase the model capacity, but also increase the model size and training/inference time.

According to some embodiments, the label or category may describe a recursion pattern of the transaction, such as “weekly”, “fortnightly”, “monthly”, or “no pattern”, for example. In some embodiments, the label or category may be a value or sequence corresponding to a recursion pattern. For example, the label “001” may correspond to a weekly recursion pattern in some embodiments.

The model parameters may control how a transaction is mapped to a recursion pattern. Prior to the first iteration, the model parameters may be set to a default value such as 0 or 1, for example. This may cause the labels generated at step 508 to be relatively random during the initial iterations of method 500. The labels may become more accurate as the model parameters are tuned after multiple iterations of method 500 have been performed.

At step 510, the model training engine 114 determines a loss function by comparing the label generated at step 508 with the known recursion pattern of each transaction.

According to some embodiments, determining the loss function may be used as a manner of penalising the model for making incorrect predictions. A correct prediction, being a prediction that matches the known recursion pattern, may result in a loss function of zero. Any derivation from the target transaction may increase the calculated loss function.

Determining the loss function may comprise determining a categorical loss function. The categorical loss function may include a binary classification loss function or a multi-class classification loss function, and may be used to quantify the difference between a predicted recursion pattern and a known recursion pattern. For example, a cross-entropy loss function may be used in some embodiments.

Where multiple sequences of transactions have been processed, the loss function may comprise the sum of the loss functions for each processed sequence of transactions.

At step 512, the model training engine 114 adjusts or tunes the model parameters to minimise the loss function determined at step 510.

At step 514, the model training engine 114 determines that a training epoch has been completed, and determines whether to continue training the model. According to some embodiments, the model training engine 114 may do this by comparing the completed number of training epochs against a predetermined number of training epochs to complete, to check whether the desired number of training epochs have been performed. In some embodiments, the model training engine 114 may alternatively determine whether to continue training by determining whether the decrease in the loss function for the last one or more sequences of training data have been below a predetermined threshold. As the change to the loss function becomes smaller from one iteration to the next, this may indicate that further training will have a negligible effect on the accuracy of the model.

If the model training engine 114 determines that more training is required, model training engine 114 may proceed to step 518, at which a new training epoch is initiated. The training dataset may be shuffled in some embodiments, and model training engine 114 continues by executing method 500 from step 506, by re-generating numerical representations for the transactions in the training dataset.

If the model training engine 114 determines that no more training is required, model training engine 114 may proceed to step 516, by storing the tuned model parameters for use in determining recursion patterns of transactions, as described above with reference to step 306 of method 300.

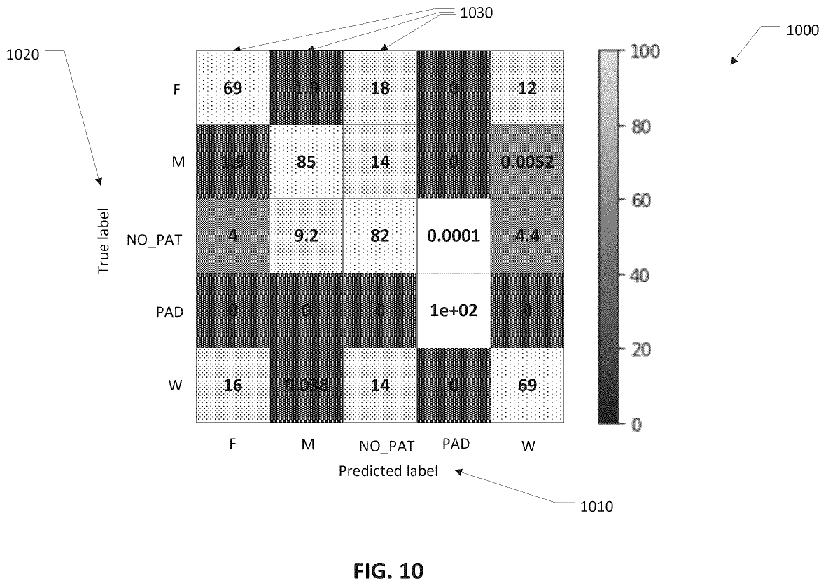

FIG. 10 is an example graph 1000 showing the results of using the methods of FIGS. 3 and 5 to predict a recursion type for a number of synthetically generated transactions. Specifically, graph 1000 was generated by using recurring transaction logic engine 112 to execute step 306 of method 300 on a synthetic dataset containing a number of transaction sequences, being:
70,000 monthly sequences with transaction amounts up to $50,000
70,000 monthly sequences with transaction amounts up to $2000
10,000 weekly sequences with transaction amounts up to $50,000
10,000 weekly sequences with transaction amounts up to $2000
20,000 fortnightly sequences with transaction amounts up to $50,000
20,000 fortnightly sequences with transaction amounts up to $2000

The total number of transactions of each sequence type is shown below:
Fortnightly: 197,985 transactions
Monthly: 385,903 transactions
No pattern: 665,278 transactions
Weekly: 175,818 transactions

Graph 1000 has an x-axis 1010 showing a predicted label as generated by recurring transaction logic engine 112 executing step 306 of method 300. Graph 1000 further has a y-axis 1020 showing the actual label for each transaction. The possible labels include fortnightly (indicated as “F”), monthly (indicated as “M”), no pattern (indicated as “NO_PAT”), padding (indicated as “PAD”), and weekly (indicated as “W”). The padding label may be applied to transactions in a sequence that may be added to pad out the sequence to a predetermined length. For example, sequences of transactions may be padded out to include 20 transactions per sequence, in some embodiments.

Values 1030 indicate the percentage of transactions having each label that were correctly predicted. As shown, transactions with the “padding” label were almost all correctly predicted. Transactions with the “fortnightly” label were predicted correctly around 69% of the time, with around 18% mislabelled as no pattern and around 12% mislabelled as weekly. Transactions with the “monthly” label were predicted correctly around 85% of the time, with around 14% mislabelled as no pattern and around 1.9% mislabelled as fortnightly. Transactions with the “no pattern” label were predicted correctly around 82% of the time, with around 9.2% mislabelled as monthly, around 4.4% mislabelled as weekly and around 4% mislabelled as fortnightly. Transactions with the “weekly” label were predicted correctly around 69% of the time, with around 16% mislabelled as fortnightly and around 14% mislabelled as no pattern.

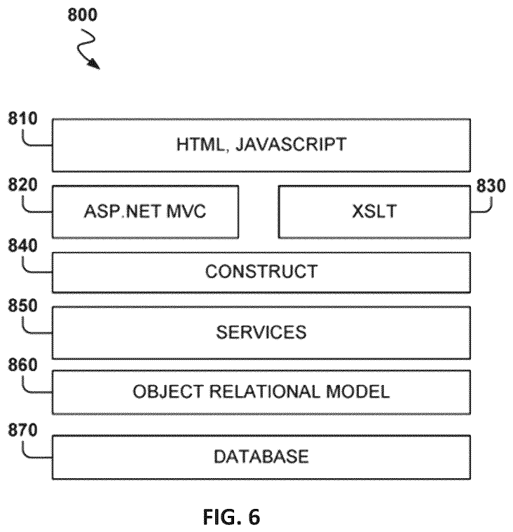

FIG. 6 is a block diagram depicting an example application framework 800, according to some embodiments. The application framework 800 may be an end-to-end web development framework enabling a “software as a service” (SaaS) product. The application framework 800 may include a hypertext markup language (HTML) and/or JavaScript layer 810, ASP.NET Model-View-Controller (MVC) 820, extensible stylesheet language transformations (XSLT) 830, construct 840, services 850, object relational model 860, and database 870.

The HTML and/or JavaScript layer 810 provides client-side functionality, such as user interface (UI) generation, receipt of user input, and communication with a server. The client-side code may be created dynamically by the ASP.NET MVC 820 or the XSLT 830. Alternatively, the client-side code may be statically created or dynamically created using another server-side tool. The ASP.NET MVC 820 and XSLT 830 provide server-side functionality, such as data processing, web page generation, and communication with a client. Other server-side technologies may also be used to interact with the database 870 and create an experience for the user.

The construct 840 provides a conduit through which data is processed and presented to a user. For example, the ASP.NET MVC 820 and XSLT 830 can access the construct 840 to determine the desired format of the data. Based on the construct 840, client-side code for presentation of the data is generated. The generated client-side code and data for presentation is sent to the client, which then presents data. In some example embodiments, when the MLP is invoked to analyze an entry, the MVC website makes an HTTP API call to a Python-based server. Also, the MVC website makes another HTTP API call to the Python-based server to present the suggestions to the user. The services 850 provide reusable tools that can be used by the ASP.NET 820, the XSLT 830, and the construct 840 to access data stored in the database 870. For example, aggregate data generated by calculations operating on raw data stored in the database 870 may be made accessible by the services 850.

The object relational model 860 provides data structures usable by software to manipulate data stored in the database 870. For example, the database 870 may represent a many-to-one relationship by storing multiple rows in a table, with each row having a value in common. By contrast, the software may prefer to access that data as an array, where the array is a member of an object corresponding to the common value. Accordingly, the object relational model 860 may convert the multiple rows to an array when the software accesses them and perform the reverse conversion when the data is stored.

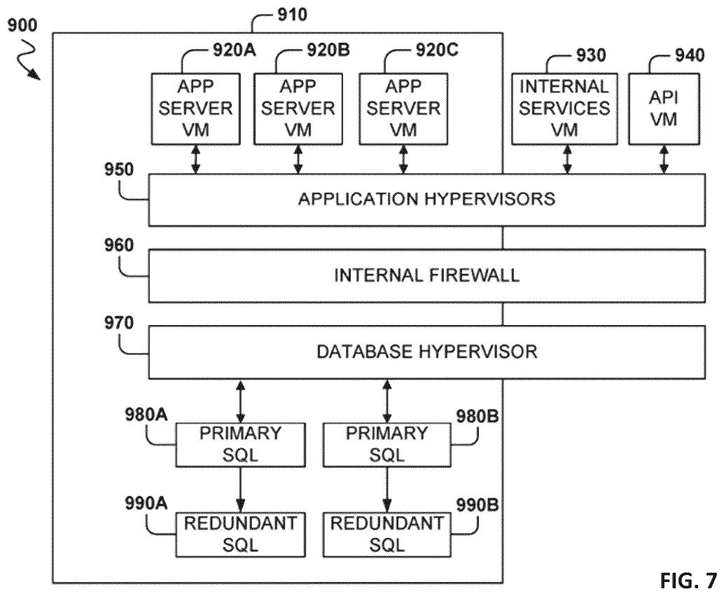

FIG. 7 is a block diagram depicting an example hosting infrastructure 900, according to some embodiments. The platform 600 may be implemented using one or more pods 910. Each pod 910 includes application server virtual machines (VMs) 920 (shown as application server virtual machines 920A-920C in FIG. 7) that are specific to the pod 910 as well as application server virtual machines that are shared between pods 910 (e.g., internal services VM 930 and application protocol interface VM 940). The application server virtual machines 920-940 communicate with clients and third-party applications via a web interface or an API. The application server virtual machines 920-940 are monitored by application hypervisors 950. In some example embodiments, the application server virtual machines 920A-920C and the API VM 940 are publicly accessible while the internal services VM 930 is not accessible by machines outside of the hosting infrastructure 900. The app server VMs 920A-920C may provide end-user services via an application or web interface. The internal services VM 930 may provide back-end tools to the app server VMs 920A-920C, monitoring tools to the application hypervisors 950, or other internal services. The API VM 940 may provide a programmatic interface to third parties. Using the programmatic interface, the third parties can build additional tools that rely on the features provided by the pod 910. An internal firewall 960 ensures that only approved communications are allowed between the database hypervisor 970 and the publicly accessible virtual machines 920-940. The database hypervisor 970 monitors the primary SQL servers 980A and 980B and the redundant SQL servers 990A and 990B. The virtual machines 920-940 can be implemented using Windows 8008 R2, Windows 8012, or another operating system. The support servers can be shared across multiple pods 910. The application hypervisors 950, internal firewall 960, and database hypervisor 970 may span multiple pods 910 within a data centre.

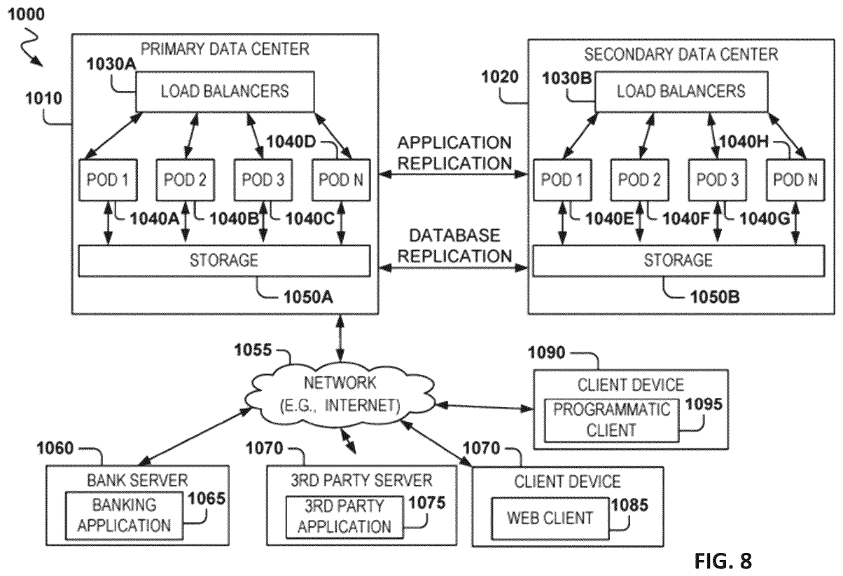

FIG. 8 is a block diagram depicting an example data centre system 1000 for implementing embodiments. The primary data centre 1010 services customer requests and is replicated to the secondary data centre 1020. The secondary data centre 1020 may be brought online to serve customer requests in case of a fault in the primary data centre 1010. The primary data centre 1010 communicates over a network 1055 with bank server 1060, third party server 1070, client device 1070, and client device 1090. The bank server provides banking data (e.g., via a banking application 1065). The third-party server 1070 is running third party application 1075. Client devices 1080 and 1090 interact with the primary data centre 1010 using web client 1085 and programmatic client 1095, respectively. Within each data centre 1010 and 1020, a plurality of pods, such as the pod 910 of FIG. 7, are shown. The primary data centre 1010 is shown containing pods 1040a-1040d. The secondary data centre 1020 is shown containing pods 1040e-1040h. The applications running on the pods of the primary data centre 1010 are replicated to the pods of the secondary data centre 1020. For example, EMC replication (provided by EMC Corporation) in combination with VMWare site recovery manager (SRM) may be used for the application layer replication. The database layer handles replication between a storage layer 1050a of the primary data centre and a storage layer 1050b of the secondary data centre. Database replication provides database consistency and the ability to ensure that all databases are at the same point in time. The data centres 1010 and 1020 use load balancers 1030a and 1030b, respectively, to balance the load on the pods within each data centre. The bank server 1060 interacts with the primary data centre 1010 to provide bank records for bank accounts of the client. For example, the client may provide account credentials to the primary data centre 1010, which the primary data centre 1010 uses to gain access to the account information of the client.

The bank server 1060 can provide the banking records to the primary data centre 1010 for later reconciliation by the client using the client device 1080 or 1090. The third-party server 1070 may interact with the primary data centre 1010 and the client device 1080 or 1090 to provide additional features to a user of the client device 1080 or 1090.

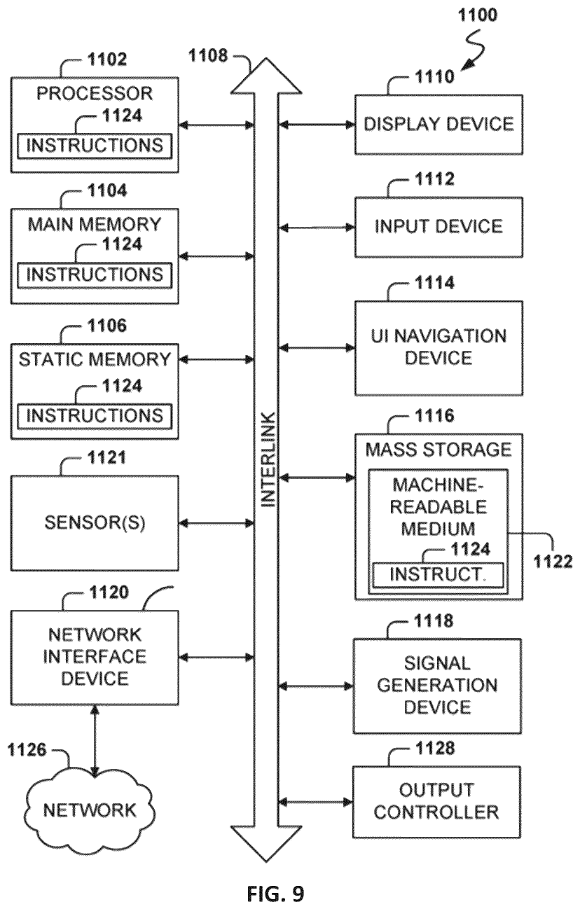

FIG. 9 is a block diagram illustrating an example of a machine upon which one or more example embodiments may be implemented. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a laptop, a mobile telephone, a web appliance, a network router, switch or bridge, or any machine capable of executing instructions (sequential or otherwise) that specify actions to be taken by that machine. Further, while only a single machine 1100 is illustrated, the term “machine” shall also be taken to include any collection of machines that individually or jointly execute a set (or multiple sets) of instructions to perform any one or more of the methodologies discussed herein, such as cloud computing, SaaS, or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1100 may include a hardware processor 1102 (e.g., a central processing unit (CPU), a graphics processing unit (GPU), a hardware processor core, or any combination thereof), a main memory 1104, and a static memory 1106, some or all of which may communicate with each other via an interlink (e.g., bus) 1108. The machine 1100 may further include a display device 1110, an alphanumeric input device 1112 (e.g., a keyboard), and a UI navigation device 1114 (e.g., a mouse). In an example, the display device 1110, input device 1112, and UI navigation device 1114 may be a touch screen display. The machine 1100 may additionally include a mass storage device (e.g., drive unit) 1116, a signal generation device 1118 (e.g., a speaker), a network interface device 1120, and one or more sensors 1121, such as a global positioning system (GPS) sensor, compass, accelerometer, or another sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions 1124 for execution by the machine 1100 and that cause the machine 1100 to perform any one or more of the techniques of the present disclosure, or that is capable of storing, encoding or carrying data structures used by or associated with such instructions 1124. Non-limiting machine-readable medium examples may include solid-state memories, and optical and magnetic media. In an example, a massed machine-readable medium comprises a machine-readable medium 1122 with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only

Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 1102.11 family of standards known as Wi-Fi®, IEEE 1102.16 family of standards known as WiMax®), IEEE 1102.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126.

In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 1124 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1.-6. (canceled)

7. A method of training a machine learning model to generate numerical representations of transaction datasets, the method comprising:
retrieving a training dataset comprising a sequence of transactions each comprising a transaction date and a transaction amount, wherein a most recent transaction in a sequence is a target transaction and other transactions are context transactions;
retrieving model parameters for the machine learning model;
causing the machine learning model to generate a numerical representation of each context transaction in the sequence based on the retrieved model parameters;
causing the machine learning model to generate a predicted target transaction including a predicted transaction date and a predicted transaction amount;
determining a loss function by comparing the target transaction to the predicted target transaction; and
adjusting model parameters to minimise the loss function.

8. The method of claim 7, wherein the numerical representation comprises a vector comprising a plurality of numerical values.

9. The method of claim 7, further comprising retrieving a new training dataset and performing the method on the new dataset.

10. The method of claim 9, further comprising performing multiple iterations of the method to tune the model parameters.

11. The method of claim 10, wherein the method is continued until a predetermined number of iterations of the method have been performed.

12. The method of claim 10, wherein the method is continued until a decrease in the loss function for a last one or more iterations falls below a predetermined threshold.

13. The method of claim 7, wherein determining the loss function comprises determining a categorical loss function.

14. The method of claim 13, wherein the categorical loss function is a cross-entropy loss function.

15. The method of claim 13, wherein the categorical loss function is calculated for each day of a month, day of a week and the month of a predicted transaction date.

16. The method of claim 7, wherein determining the loss function comprises determining a regression loss function.

17. The method of claim 16, wherein the regression loss function is a mean squared error loss function.

18. The method of claim 7, wherein determining the loss function comprises determining more than one preliminary loss functions and combining each preliminary loss function into a single loss function.

19.-35. (canceled)

36. A system, comprising:
one or more processors; and
memory comprising computer executable instructions, which when executed by the one or more processors, cause the system to train a machine learning model to generate numerical representations of transaction datasets by:
retrieving a training dataset comprising a sequence of transactions each comprising a transaction date and a transaction amount, wherein a most recent transaction in a sequence is a target transaction and other transactions are context transactions;
retrieving model parameters for the machine learning model;
causing the machine learning model to generate a numerical representation of each context transaction in the sequence based on the retrieved model parameters;
causing the machine learning model to generate a predicted target transaction including a predicted transaction date and a predicted transaction amount;
determining a loss function by comparing the target transaction to the predicted target transaction; and
adjusting model parameters to minimise the loss function.

37. The system of claim 36, wherein the numerical representation comprises a vector comprising a plurality of numerical values.

38. The system of claim 36, further comprising retrieving a new training dataset and executing the instructions on the new dataset.

39. The system of claim 36, further comprising performing multiple iterations of the instructions to tune the model parameters.

40. A non-transitory computer-readable medium storing a computer program comprising processing instructions which, when executed by a computing apparatus, cause the computing apparatus to train a machine learning model to generate numerical representations of transaction datasets by:
retrieving a training dataset comprising a sequence of transactions each comprising a transaction date and a transaction amount, wherein a most recent transaction in a sequence is a target transaction and other transactions are context transactions;
retrieving model parameters for the machine learning model;
causing the machine learning model to generate a numerical representation of each context transaction in the sequence based on the retrieved model parameters;
causing the machine learning model to generate a predicted target transaction including a predicted transaction date and a predicted transaction amount;
determining a loss function by comparing the target transaction to the predicted target transaction; and
adjusting model parameters to minimise the loss function.

41. The non-transitory computer-readable medium of claim 40, wherein the numerical representation comprises a vector comprising a plurality of numerical values.

42. The non-transitory computer-readable medium of claim 40, further comprising retrieving a new training dataset and processing the instructions on the new dataset.

43. The non-transitory computer-readable medium of claim 40, further comprising performing multiple iterations of the instructions to tune the model parameters.
